(19) United States
(12) Patent Application Publication
(10) Pub. No.: US 2004/0019698 A1
(43) Pub. Date: Jan. 29, 2004

(54) Method and system of registering a geoname for a geolocation and matching attributes of the geolocation

(76) Inventor: Hamid Najafi, Los Altos Hills, CA (US)

Correspondence Address: Robert D. Becker, Manatt, Phelps & Phillips LLP, 1001 Page Mill Road, Building 2, Palo Alto, CA, 94034, US

(21) Appl. No.: 10/201,800

(22) Filed: Jul. 24, 2002

(51) Int. Cl. G06F 15/16

(52) U.S. Cl. 709/245

(57) ABSTRACT

A method and system are provided for registering a geolocation and for matching the geolocation with latitude and longitude coordinates based on its geoname. The system functions through the inter-action between satellites, satellite receivers, a computer system, the Internet, to provide a matching system between a given geoname and its geolocation. Users subscribe to a service to have easy access via the Internet to the information received from a server identified as a Universal Geoname Registry that includes in its database the latitude and longitude coordinates, the physical address and other similar attributes. The commonality of each set of coordinates is the geoname, which can henceforth replace conventional addresses. For example, a user logging on to the Internet can access map servers and obtain direction to based on the geoname of a particular geolocation.

### FIELD OF INVENTION

The present invention relates generally to a method and system for establishing a registry of names for specific geographically oriented locations, i.e., geolocations, and for matching each of the geolocations with its latitude and longitude coordinates.

### BACKGROUND OF THE INVENTION

In the recent years, electronic mapping has become widely used in applications to provide directions to an address of a given location, e.g., MAPQUEST.COM, car navigational systems, e.g., General Motors' OnStar system, and other location-based services such as location based advertising, emergency road side assistance, and fleet tracking.

In a typical application, a user tries to obtain directions to a specific address by accessing an electronic map, either via the Internet using, for example MAPQUEST or mapping software, e.g., MapInfo. The user enters the street address of the location and the mapping system matches the address to a specific location on the map and provides turn-by-turn directions to that address from a starting location. This approach is very convenient as long as the user has the correct address to a particular location and can easily enter the address via a computer keyboard or other input means. However, if the user is trying to find the directions to a particular business and the only information available at the time is the name of the business, this approach cannot be used. In such cases, the user must first find the address to the particular business location before inputting the address into a mapping service.

Therefore, there is a need for a method and a system for greatly simplifying the prior art methods for obtaining the directions to a given geolocation. There is also a need for a method and a system that can be used to allow individuals to maintain their home addresses and other similar information confidential while still allowing for delivery of mail, packages, and other items to their homes.

### SUMMARY OF THE INVENTION

In one embodiment of the present invention, a method and system are disclosed for registering a given geolocation and for matching that geolocation with its latitude and longitude coordinates. The method comprises the steps of:

(a) determining the latitude and longitude coordinates for each of a plurality of given geolocations;

(b) identifying each of the geolocations with its own unique geoname;

(c) sending each of the geonames having the associated latitude and longitude coordinates to a universal geoname register (UGR);

(d) receiving into the UGR a query based on a geoname selected by a user; and

(e) matching the selected geoname with its associated latitude and longitude coordinates.

One application for the foregoing method is to obtain a map to a geolocation having a geoname registered in the UGR using a car navigation system based on a Global Positioning System (GPS) that has the ability to calculate the car's exact position on the earth with the help of the satellite system. The user simply inputs the geoname into the navigational system and the geoname is sent directly to the UGR. The navigation system instantly provides a map from the car's geolocation to the geoname's geolocation.

Another application is to use a location-enabled personal digital assistant (PDA), e.g., a Route Planner” application developed by UK-based Palmtop Software. As in the above application, the user inputs the geoname and the PDA displays a map to the desired geolocation.

In most others applications, the most important attribute to be attached to the latitude and longitude coordinates is the physical address or street address of the particular business or residence. This greatly expands the utility of the method and the system of the present invention.

### BRIEF DESCRIPTION OF THE DRAWING

Further features and advantages will become apparent from the following and more particular description of the preferred embodiment of the invention, as illustrated in the accompanying drawing in which:

FIG. 1 is a block diagram of representative hardware of the system of the present invention.

### DETAILED DESCRIPTION OF THE PREFERRED EMBODIMENT OF THE PRESENT INVENTION

A method and system for registering a given geolocation and for matching that geolocation with its latitude and longitude coordinates is described in detail below.

The method begins with the step of establishing the specific latitude and longitude coordinates for specific geographically oriented locations, which have been defined herein as the geolocations using either GPS or other systems for establishing the exact latitude and longitude of a given geolocation. At the present time, 24 satellites along with their ground stations calculate positions on earth that is accurate down to about a mete. With advanced forms of GPS, the accuracy can be down to a centimeter. Therefore, at least every square meter of a geolocation can be given a unique address. While many of the geolocations that are contemplated for inclusion in the method of the present invention occupy a geospace that is considerably greater than a square meter, an office building or apartment may require the advanced forms of GPS. This will permit a large number of occupants for a given building to have a number of distinct geolocations, each having its own separate set of coordinates.

The exact coordinates for a given geolocation are established using a GPS receiver, a controller, a GPS antenna, a RTK (real time kinematics) radio, and processing software, see for example, the Trimble GPS Total Station system. The owners, lessees or other occupants (hereinafter referred to as the occupants) choose a unique geoname, usually alpha numeric, for each given set of coordinates. Typical geonames may simply be the first and last name of the occupant of the geolocation. For example, Senator Feinstein may select “Diane Feinstein office” as her geoname to be used for the mail to be delivered to her office or Nicole Kidman may choose “Nicole-Kidman” as the geoname for all her fan mail, and San Francisco 49ers may choose “49ers” as the geoname for their mailing address and/or office location. People may also choose geonames for their home addresses. For instance, one may register “home sweet home”, another could select “my home”, and Jack Brown in Des Moines Iowa may choose “Jack Brown's home” as his exclusive geoname.

Once a given set of coordinates has been identified by a unique geoname, that geolocation will be matched to the selected geoname until the occupant changes the geolocation. Each of the selected geonames and its associated coordinates are sent to the registry known herein as the Universal Geolocation Register (UGR), a database located in a central server. The server can be any present or future computing device with sufficient memory and processor speed to handle the data input and manipulation required. This server is accessible on a worldwide basis via the Internet. A user accesses the UGR Web page of the UGR server to make a query. By inputting the exact case sensitive geoname into the appropriate window of the Web page, the UGR makes a match between the geolocation and the geoname.

Today, many cars have a GPS-based navigation system and it is expected that a majority of cars will have them in the future. If a user of the present method is in Chicago and is looking for the directions to downtown hotel, all the user is required to do is to enter (via keys or voice commands) the geoname into the navigation system for its location. The hotel's geoname could simply be “Downtown Hotel.” The navigation system will be programmed to send this geoname to the UGR central server via its wireless connection, and will obtain the geoname's corresponding latitude/longitude and provide directions to the user. The foregoing functions can be applied to a location enabled PDA. There is need for a user to remember or enter long addresses with the method of the present invention.

Businesses can have a geoname for their mailing address. Using the method of the present invention, mail to that location does not need the usual address. All a business requires is a geoname printed on the mailing label. The geoname can be easily read by sorting machines, resulting in lower cost of mail service and less possibility of human error. This is especially important in countries in Asia or Africa, where addresses are typically very long and thus are more prone to human errors in reading them. TV, and especially radio, commercials typically have to repeat the phone numbers of their advertisers many times so the audience remembers them. Some have to reserve special easy-to-remember phone numbers, e.g., 1-800-pick-UPS, 1-888-Flowers, and the like. The listeners find it much easier to remember a geoname like UPS, or FTD, than these phone numbers. Using the geoname, the buyers or prospective buyers can send a query for addresses, phone numbers, and other information for the advertiser through their wired or wireless Internet connections. Businesses with easy-to-remember geonames will benefit from customers being able to find their geolocation without difficulty. Geonames can replace the occupant's street addresses on driver licenses, bank, checks, and similar identification.

Today, one can easily access the Internet using a laptop computer, mobile phones, PDA's, and other wireless application protocol (WAP) products, e.g., WAP-enabled cellular phones. All such devices are contemplated for a user to make queries of the UGR of the present invention When an occupant moves from one geolocation to another, there is no need to let everyone know the new address. The occupant keeps the same geoname and all that is required to update an address, and optionally phone and fax numbers, email addresses, and other information, is to notify the UGR and have the new geolocation surveyed for its latitude and longitude. Businesses save a lot of money not having to reprint new stationary, business cards and the like. The post office in the various countries, DSL, Federal Express, UPS, and other mail carriers can receive up-to-date addresses for the occupants from the UGR no matter where the occupants move to, as long as the same geoname is maintained.

Occupants who want to protect their privacy can release their geonames but request from the UGR that password protection be given to their addresses, phone numbers, and other such attributes. Only those who know the password can access the UGR to obtain these attributes. If an occupant moves and no longer wants a person who had the occupant's password to find the forwarding address, the occupant can simply change the password while keeping the same geoname. If that person tried to send correspondence to the occupant's old address, it will not be delivered after the forwarding service period by the USPS expires (typically one year).

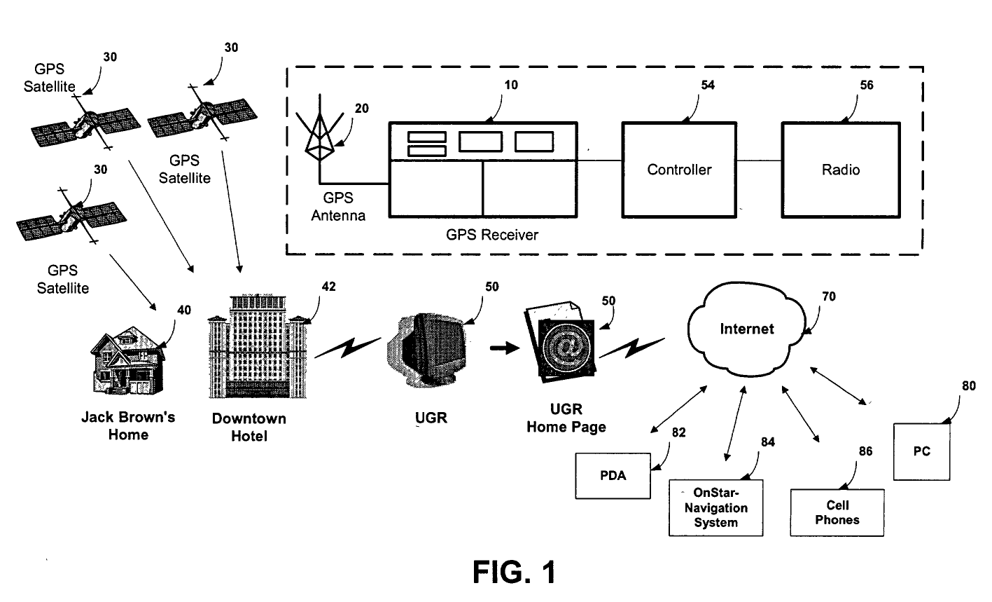

Since an occupant's physical location, latitude and longitude, is attached to the geoname in the UGR, the postal services can automate mail sorting without the need for nine (or more) digits for zip codes. In fact, there is no need for a zip code anymore, with the use of the method of the present invention Referring now to FIG. 1, GPS receiver 10 receives signals via GPS antenna 20 sent out from one of the GPS satellites 30. GPS is a worldwide satellite directed radio navigation system GPS developed by the United States Government. GPS provides a one-way transmission of positioning messages to receivers on a global basis. GPS satellites provide a number of functions including enabling the calculation of the latitude and longitude of residence 40 given the geoname of “Jack Brown's Home”, a place of business 42 given the geoname of “Downtown Hotel”, and other geolocations. The calculations from the satellite are sent in satellite data format and are transmitted into UGR 50 via controller 54 and radio 56. Typically, a portable system, including GPS receiver 10, antenna 20, controller 54, radio 56, is located at the geolocation to determine the coordinates.

UGR server 50 provides storage medium to host data consisting of the latitude/longitude data to which is attached the given geoname. Server 50 compiles and disseminates this data into readable information. It is capable of interfacing with any query from a user using a variety of different modes. The system automatically creates and continues updating itself for access on the Internet via a web page by any device, such as a personal computer, hand-held PC and WAP phones, using an operating system, such as Windows or Linux. UGR 50 also is a host to UGR homepage 60 accessible via the Internet 70. A user logs on using a personal computer 80, PDA 82, car navigation system 84, or cell phones 86, or similar devices, and enters the geoname into the Web page homepage 60. Depending on the particular application, a password may also be entered if the information being sought is attribute information that the occupant wishes to remain confidential. The UGR server 50 then matched the geoname entered by the user as discussed above.

Without departing from the spirit and scope of this invention, one of ordinary skill in the art can make various changes and modifications to the invention to adapt it to various usages and conditions. For example, the method and system of the present invention has been illustrated using representative hardware. However, the invention is equally adaptive to the use of hardware that is likely to have widespread use in the future. As such, these changes and similar modifications are properly, equitably, and intended to be, within the full range of equivalents of the following claims.

What is claimed is:

1. A method for registering a geolocation and for matching the geolocation with latitude and longitude coordinates comprising the steps of:
(a) determining the latitude and longitude coordinates for each of a plurality of given geolocations;
(b) identifying each of the geolocations with its own unique geoname;
(c) sending each of the geonames having the associated latitude and longitude coordinates to a universal geoname register (UGR);
(d) receiving into the UGR a query based on a geoname selected by a user; and
(e) matching the selected geoname with its associated latitude and longitude coordinates.

2. The method of claim 1, wherein the query of step (d) is received from an automobile navigation system and the system receives the geolocation based on step (e) and displays a map from the system to the geolocation.

3. The method of claim 1, wherein the query of step (d) is received from a location-enabled personal digital assistant (PDA) and the PDA receives the geolocation based on step (e) and displays a map from the PDA to the geolocation.

4. The method of claim 1, wherein at least one attribute of the geolocation is correlated and attached to the latitude and longitude coordinates within the UGR for the geolocation.

5. The method of claim 4, wherein one attribute is the mailing address of the geolocation.

6. The method of claim 5, wherein the geolocation is the site of a business.

7. The method of claim 5, wherein the geolocation is the site of a residence.

8. The method of claim 5, wherein mail is addressed to the geoname for delivery to the geolocation.

9. The method of claim 6, wherein the query of step (d) is received from a customer's wired or wireless Internet connection to make an order for services or products of the business.

10. The method of claim 7, wherein an occupant of the residence uses the geoname to replace an address on an identification card of the occupant.

11. The method of claim 7, wherein an occupant of the residence uses the geoname to replace an address on a bankcard.

12. The method of claim 7, wherein an occupant of the residence maintains the same geoname and sends the new latitude and longitude coordinates to the UGR in the event of a change in geolocation.

13. The method of claim 5, wherein another attribute is the name of an occupant of the geolocation.

14. The method of claim 13, wherein another attribute is the occupant's email address.

15. The method of claim 5, wherein another attribute is the telephone number associated with the geolocation.

16. The method of claim 5, wherein another attribute is the facsimile number associated with the geolocation.

17. The method of claim 5, wherein geoname replaces the U.S. Post Service (USPS) ZIP code on mail.

18. The method of claim 5, wherein step (d) is accompanied by a step of entering a password before step (e).

19. The method of claim 13, wherein a telephone directory lists the geoname in place of the name of the occupant and the occupant's address.

20. The method of claim 6, wherein the geoname is prominently displayed on a business's building in place of other indication of address.

21. The method of claim 20, wherein the query of step (d) is sent from a communication device by an individual seeking help at a particular geolocation.

22. The method of claim 5, wherein the query of step (d) is sent by a service provider to determine if that geolocation is in the area of coverage by that provider

23. A method for registering a geolocation and for matching the geolocation with latitude and longitude coordinates comprising the steps of:
(a) determining the latitude and longitude coordinates for each of a plurality of given geolocations;
(b) correlating at least the mailing address attribute of the geolocation and attaching this attribute to the latitude and longitude coordinates for that geolocation;
(c) identifying each of the geolocations with its own unique geoname;
(d) sending each of the geonames having the associated latitude and longitude coordinates and the attached attribute to a universal geoname register (UGR);
(e) receiving a query based on a geoname selected by a user into the UGR; and
(f) matching the selected geoname with its associated latitude and longitude coordinates.

24. The method of claim 23, wherein mail is addressed to the geoname for delivery to the geolocation.

25. The method of claim 24, wherein the geolocation is the site of a business.

26. The method of claim 24, wherein the geolocation is the site of a residence.

27. A system for registering a geolocation and for matching the geolocation with latitude and longitude coordinates, comprising:
(a) GPS receiver in one-way communication with a plurality of GPS global positioning system satellites for determining the latitude and longitude coordinates of a plurality of geolocations, each having its own unique geoname;
(b) a UGR server for downloading and storing the geolocation data from the communications satellite and associated geonames and storing the data;
(c) means within the UGR for matching the geolocation data stored in the UGR server to a web to enable on-line access to the data upon a query from a user of the system.
